(19) United States
(12) Patent Application Publication
(10) Pub. No.: US 2026/0142405 A1
(43) Pub. Date: May 21, 2026

(54) MEMORY WITH TELESCOPIC DATA CONNECTOR

(71) Applicant: Guangdong Super Industry Group Co., Ltd, Foshan (CN)

(72) Inventors: Zhuowen LIAO, Foshan (CN); Jiewen GUO, Foshan (CN)

(21) Appl. No.: 18/988,834

(22) Filed: Dec. 19, 2024

(30) Foreign Application Priority Data
Nov. 19, 2024 (CN) 202422830423.8

(51) Int. Cl. H01R 13/508; H01R 13/629

(52) U.S. Cl. CPC H01R 13/508; H01R 13/62922

(57) ABSTRACT

Disclosed is a memory with a telescopic data connector. The memory (100) with the telescopic data connector comprises a shell (10); a male connector assembly (20) elastically connected with the shell (10), and having an accommodating state of retracting into the shell (10) and an extending state of extending from the shell (10); a limiting member (30) arranged in the shell (10), the limiting member (30) limiting the male connector assembly (20) from ejecting from the shell (10) in the accommodating state, and the limiting member (30) limiting the male connector assembly (20) from retracting into the shell (10) in the extending state; and a controller (40) arranged on the shell (10), the controller (40) being used for controlling the limiting member (30) to move, and the movement of the limiting member (30) allowing the male connector assembly (20) to extend and retract elastically.

### TECHNICAL FIELD

The present invention relates to the field of auxiliary devices, in particular to a memory with a telescopic data connector.

### BACKGROUND OF THE PRESENT INVENTION

With the growth of data and the complexity of data processing, portable memory devices are widely used in life and work. At present, most memory devices in the market still use traditional plug-in interfaces, such as a USB interface, but this design is easily damaged by external environment, such as dust, moisture, friction and impact, in a use process, leading to the damage of interfaces or the instability of data transmission. Moreover, users often encounter the problem of interface loss during plugging and unplugging, especially in the case of frequent use, the service life of the memory devices is easily affected.

According existing telescopic interface designs, such as a spring-pressed telescopic solid-state USB flash drive disclosed in patent CN205488714U, a telescopic function of an interface is achieved by pressing a spring mechanism, but this USB flash drive has a simple function and a complex structure. In addition, CN112952486A discloses a multi-mode connection interface and a control method thereof, which proposes to realize compatibility and data transmission control between different devices through the multi-mode interface. This design is innovative in improving the compatibility of device to a certain extent, but the complex control method and interface structure increase production costs to a certain extent, and meanwhile, the excessively complicated design may also affect the user experience and the stability of device.

Therefore, there are still problems of insufficient interface protection, complex mechanical structure, single function and excessively complicated compatibility design in the prior art.

### SUMMARY OF THE PRESENT INVENTION

The present invention is mainly intended to provide a memory with a telescopic data connector, and aims at solving the above problems of complex structure, single function and insufficient interface protection of an existing memory with a telescopic data connector, and the memory with the telescopic data connector comprises:
a shell;
a male connector assembly, wherein the male connector assembly is elastically connected with the shell, and has an accommodating state of retracting into the shell and an extending state of extending from the shell; and the male connector assembly is used for connecting an electronic device;
a limiting member, wherein the limiting member is arranged in the shell, the limiting member limits the male connector assembly from ejecting from the shell in the accommodating state, and the limiting member limits the male connector assembly from retracting into the shell in the extending state; and
a controller, wherein the controller is arranged on the shell, the controller is used for controlling the limiting member to move, and the movement of the limiting member allows the male connector assembly to extend and retract elastically, so as to change the male connector assembly from the accommodating state to the extending state by ejecting from the shell, or change the male connector assembly from the extending state to the accommodating state by retracting into the shell.

Optionally, the limiting member comprises a first movable portion and a second movable portion, a first distance exists between the first movable portion and the second movable portion, the controller is arranged between the first movable portion and the second movable portion, and the controller is pressed to increase the first distance, so as to release a limitation on the male connector assembly.

Optionally, the first movable portion is provided with a first inclined plane, and the second movable portion is provided with a second inclined plane; the controller abuts against the first inclined plane and the second inclined plane respectively; and when the controller is pressed, the controller slides along the first inclined plane and the second inclined plane at the same time, so as to squeeze out the first movable portion and the second movable portion.

Optionally, the first movable portion is connected with the shell through a first elastic member, and the second movable portion is connected with the shell through a second elastic member; when the controller is pressed, the first movable portion and the second movable portion compress the first elastic member and the second elastic member respectively; and after the first elastic member and the second elastic member are compressed, an elastic force is provided for restoring the first movable portion and the second movable portion.

Optionally, the first movable portion is provided with a first limiting wall, the second movable portion is provided with a second limiting wall, the first limiting wall and the second limiting wall extend to approach each other, and the controller is pressed to make the first limiting wall and the second limiting wall move away from each other and release the male connector assembly for elastic movement.

Optionally, the male connector assembly retracts between the first limiting wall and the second limiting wall in the accommodating state, the male connector assembly abuts against an inner wall of the first limiting wall and an inner wall of the second limiting wall, and is compressed by the first limiting wall and the second limiting wall, and the male connector assembly is limited from extending from the shell.

Optionally, the first movable portion is provided with a first groove and a first guide portion, the first guide portion is arranged on one side of the first limiting wall, the second movable portion is provided with a second groove and a second guide portion, the second guide portion is arranged on one side of the second limiting wall, and the male connector assembly moves telescopically between the first guide portion and the second guide portion.

Optionally, one end of the controller is provided with a pressing portion and a moving portion, the pressing portion is arranged on a surface of the shell, two sides of the moving portion abut against the first movable portion and the second movable portion, the other end of the controller is elastically connected to an inner wall of the shell, and the pressing portion is pressed to make the moving portion squeeze out the first movable portion and the second movable portion.

Optionally, the male connector assembly comprises an annular portion and a first interface; the first interface is used for connecting the electronic device, the annular portion is used for clamping the first interface, the annular portion is connected with the shell through a third elastic member and carries the first interface to move synchronously; and when the first interface extends from the shell, a bottom surface of the annular portion abuts against the first movable portion and the second movable portion.

Optionally, the memory with the telescopic data connector further comprises a second interface, the second interface is arranged in the shell, and the second interface is used for connecting the electronic device.

According to the technical solution of the present invention, the male connector assembly is accommodated and hidden by limiting the male connector assembly from ejecting from the shell through the limiting member, the limiting member limits the male connector assembly from retracting into the shell in the extending state to support the male connector assembly, and when in use, the elastic movement of the limiting member is controlled by the controller to change the male connector assembly from the accommodating state to the extending state, or change the male connector assembly from the extending state to the accommodating state, so as to achieve the technical effect that the male connector assembly is fixed outside the shell when in use and accommodated in the shell when not in use, and moreover, due to the simple structure, a user does not need to carry out other operations.

### DESCRIPTION OF THE DRAWINGS

In order to illustrate technical solutions in embodiments of the present invention or in the prior art more clearly, the drawings to be used in the descriptions of the embodiments or the prior art will be briefly described hereinafter. Obviously, the drawings in the following descriptions are merely some embodiments of the present invention, and for those of ordinary skills in the art, other drawings may also be obtained based on the structures shown in these drawings without going through any creative work.

FIG. 1 is a schematic diagram of an internal structure of a memory 100 with a telescopic data connector of the present invention;

FIG. 2 is a schematic diagram of a local structure of a male connector assembly 20 in an extending state in the memory 100 with the telescopic data connector of the present invention;

FIG. 3 is a schematic diagram of an internal structure of a shell 10 of the present invention;

FIG. 4 is a schematic structural diagram of a first movable portion 31 of the present invention;

FIG. 5 is a schematic structural diagram of a limiting member 30 of the present invention;

FIG. 6 is a schematic diagram of a local structure of the male connector assembly 20 in an accommodating state of the present invention;

FIG. 7 is a schematic structural diagram of the male connector assembly 20 in the accommodating state of the present invention from another perspective; and

FIG. 8 is a schematic structural diagram of the memory 100 with the telescopic data connector of the present invention.

### DESCRIPTION OF REFERENCE NUMERALS

| Numeral | Name | Numeral | Name |
|---|---|---|---|
| 100 | Memory with telescopic | 32 | Second movable |
| | data connector | | portion |
| 10 | Shell | 321 | Second inclined plane |
| 20 | Male connector assembly | 322 | Second limiting wall |
| 21 | Annular portion | 323 | Second groove |
| 22 | First interface | 324 | Second guide portion |
| 30 | Limiting member | 40 | Controller |
| 31 | First movable portion | 41 | Pressing portion |
| 311 | First inclined plane | 42 | Moving portion |
| 312 | First limiting wall | 51 | First elastic member |
| 313 | First groove | 52 | Second elastic member |
| 314 | First guide portion | 53 | Third elastic member |
| | | 60 | Second interface |

The achievement of objectives, the functional features and the advantages of the present invention will be further described with reference to the drawings and the embodiments.

### DETAILED DESCRIPTION OF PREFERRED EMBODIMENTS

Technical solutions in embodiments of the present invention will be clearly and completely described hereinafter with reference to the drawings in the embodiments of the present invention. Obviously, the described embodiments are only some but not all of the embodiments of the present invention. Based on the embodiments of the present invention, all other embodiments obtained by those of ordinary skills in the art without going through any creative work shall fall within the scope of protection of the present invention.

It shall be noted that all directional indications (such as upper, lower, left, right, front, rear, etc.) in the embodiments of the present invention are only used to explain the relative positional relationship, movement condition, etc. among various components under a certain specific posture (as shown in the drawings), and if the specific posture is changed, the directional indications are also changed accordingly.

Moreover, the descriptions related to “first”, “second”, etc. in the present invention are used for descriptive purposes only and cannot be understood as indicating or implying relative importance, or implicitly indicating the number of technical features indicated thereby. Thus, the feature defined by “first” and “second” may explicitly or implicitly comprise at least one feature. In addition, the technical solutions in the embodiments can be combined with each other, which shall be on the basis that the combination can be realized by those of ordinary skills in the art, when the combination of the technical solutions is contradictory or cannot be realized, it shall be considered that the combination of the technical solutions does not exist and does not fall within the scope of protection of the present invention.

The present invention provides a memory 100 with a telescopic data connector. With reference to FIG. 1, the memory 100 with the telescopic data connector comprises a shell 10, a male connector assembly 20, a limiting member 30 and a controller 40. For the male connector assembly 20, the male connector assembly 20 is elastically connected with the shell 10, the male connector assembly 20 has an accommodating state of retracting into the shell 10 and an extending state of extending from the shell 10, and the male connector assembly 20 is used for connecting an electronic device, such as a mobile phone, a tablet computer and a computer. The limiting member 30 is arranged in the shell 10, the limiting member 30 limits the male connector assembly 20 from ejecting from the shell 10 in the accommodating state, and the limiting member 30 limits the male connector assembly 20 from retracting into the shell 10 in the extending state. The controller 40 is arranged on the shell 10, which may be limited by arranging a baffle or a switch, and the controller 40 is used for controlling the limiting member 30 to extend and retract elastically, so as to change the male connector assembly 20 from the accommodating state to the extending state by ejecting from the shell 10, or change the male connector assembly from the extending state to the accommodating state by retracting into the shell 10. An elastic member may be resilient rubber or a spring.

Therefore, the male connector assembly 20 is limited from ejecting from the shell 10 through the limiting member 30 to accommodate and hide the male connector assembly 20. In the extending state, the limiting member 30 supports the male connector assembly 20 and makes the male connector assembly 20 extend elastically, so that the male connector assembly is released by the controller 40 to retract into the shell 10, thus entering the accommodating state. In the accommodating state, the limiting member 30 compresses the male connector assembly 20, so that the male connector assembly is released by the controller 40 to eject from the shell 10. When in use, the elastic movement of the limiting member is controlled by pressing the controller to change the male connector assembly from the accommodating state to the extending state, or change the male connector assembly from the extending state to the accommodating state, so as to achieve the effect that the male connector assembly is fixed outside the shell when in use and accommodated in the shell when not in use, thus protecting the male connector assembly. Moreover, the simple structure facilitates operation.

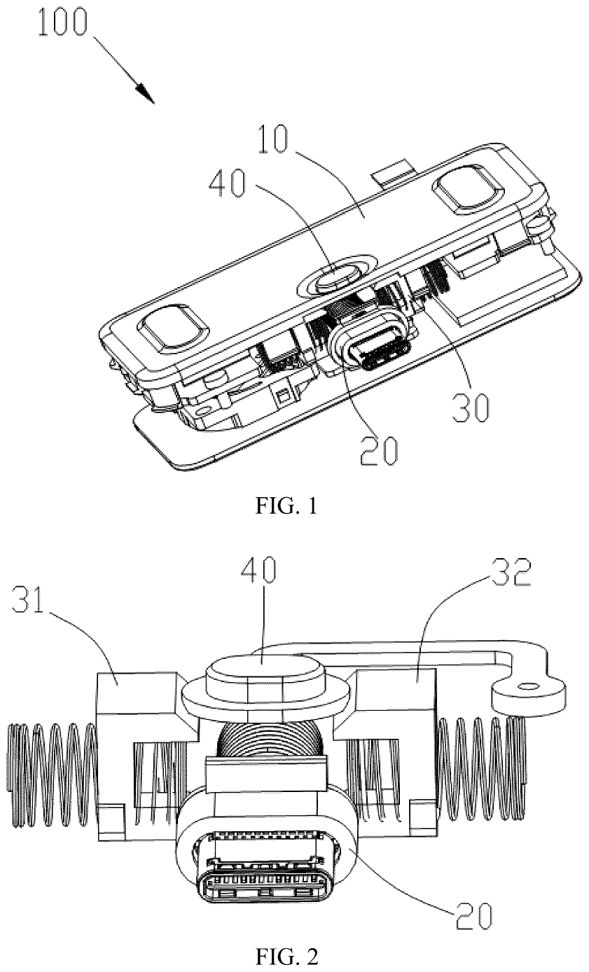

In this embodiment, with reference to FIG. 2, the limiting member 30 comprises a first movable portion 31 and a second movable portion 32, and a first distance exists between the first movable portion 31 and the second movable portion 32. Specifically, the male connector assembly 20 is arranged between the first movable portion 31 and the second movable portion 32, which facilitates elastic movement. The controller 40 is arranged between the first movable portion 31 and the second movable portion 32, and located above the male connector assembly 20. The controller 40 is pressed to increase the first distance, and the first movable portion 31 and the second movable portion 32 move in opposite directions until the first movable portion 31 and the second movable portion 32 no longer limit the male connector assembly 20, so that the male connector assembly 20 ejects from the shell 10 to enter the extending state, or the controller 40 is pressed to increase the first distance, until the first movable portion 31 and the second movable portion 32 no longer support the male connector assembly 20, and the male connector assembly 20 retracts into the shell, so that the male connector assembly 20 retracts to enter the accommodating state.

Further, the first movable portion 31 is provided with a first inclined plane 311, and the controller 40 abuts against the first inclined plane 311 and moves along the first inclined plane 311, so that the distance between the first movable portion 31 and the second movable portion 32 is increased. In this way, the male connector assembly 20 is controlled to enter the accommodating state or the extending state through the first movable portion 31. Optionally, in this embodiment, the second movable portion 32 is provided with a second inclined plane 321, the first inclined plane 311 and the second inclined plane 321 are arranged oppositely, a distance between the first inclined plane 311 and the second inclined plane 321 is gradually reduced from top to bottom, and the controller 40 slides along the first inclined plane 311 and the second inclined plane 321, so that the first movable portion 31 and the second movable portion 32 move close to or far away from each other.

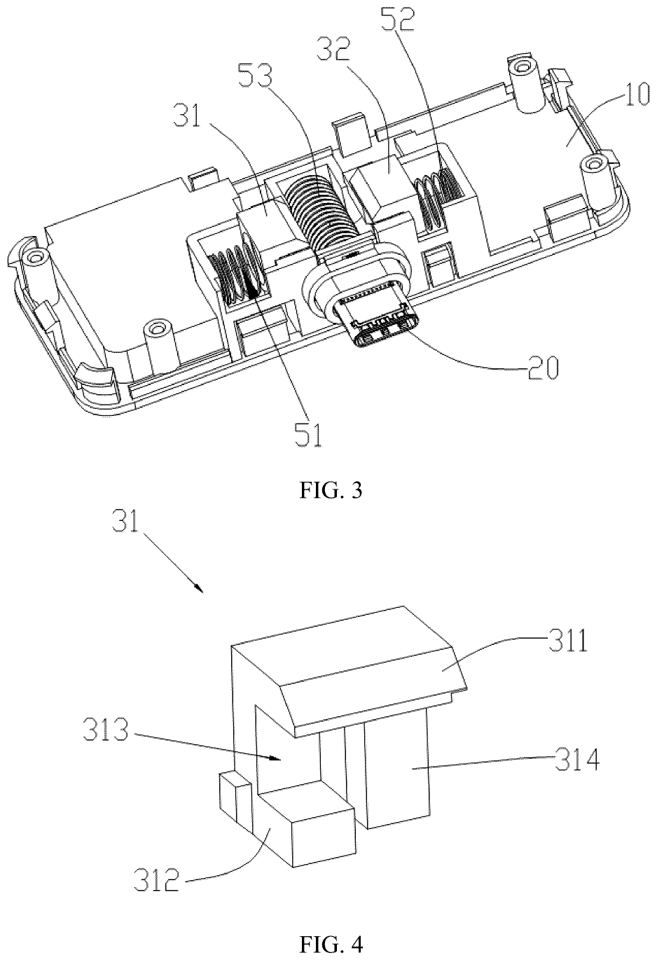

Further, with reference to FIG. 3, the first movable portion 31 is connected with the shell 10 through a first elastic member 51, and the second movable portion 32 is connected with the shell 10 through a second elastic member 52, so that the first movable portion 31 and the second movable portion 32 extend and retract elastically. When the controller 40 is pressed, the first movable portion 31 and the second movable portion 32 compress the first elastic member 51 and the second elastic member 52 respectively; and after the first elastic member 51 and the second elastic member 52 are compressed, an elastic force is provided for restoring the first movable portion 31 and the second movable portion 32, so that after the controller 40 is pressed each time, the first movable portion 31 and the second movable portion 32 recover elasticity to for repeated pressing.

Based on the above embodiment, the first movable portion 31 is provided with a first limiting wall 312, the second movable portion 32 is provided with a second limiting wall 322, and the first limiting wall 312 and the second limiting wall 322 extend to approach each other. The male connector assembly 20 has elasticity, in the accommodating state, the male connector assembly 20 abuts against an inner wall of the first limiting wall 312 and an inner wall of the second limiting wall 322, and the male connector assembly 20 is squeezed, with a certain elasticity, and in the extending state, an outer wall of the first limiting wall 312 and an outer wall of the second limiting wall 322 abut against the male connector assembly 20 to prevent the male connector assembly 20 from retracting. At this time, the male connector assembly 20 is stretched to extend from the shell 10, and the first limiting wall 312 and the second limiting wall 322 provide support for a first interface 22, so as to facilitate plugging an electronic device into the first interface 22.

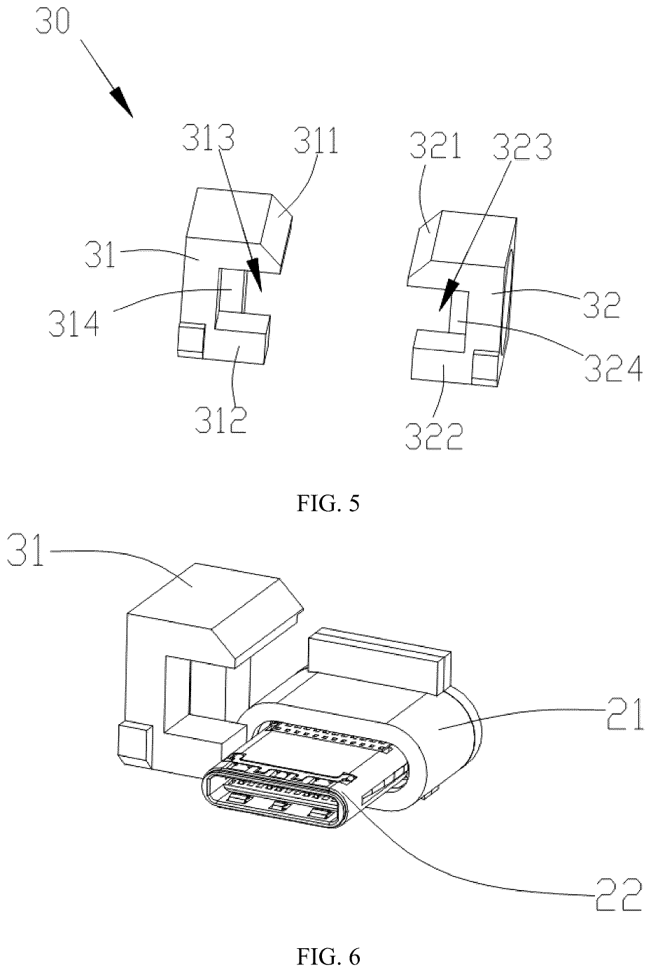

Based on the above embodiment, with reference to FIG. 4 and FIG. 5, the first movable portion 31 is provided with a first groove 313 and a first guide portion 314, the first guide portion 314 is arranged on one side of the first limiting wall 312, the second movable portion 32 is provided with a second groove 323 and a second guide portion 324, the second guide portion 324 is arranged on one side of the second limiting wall 322, and the male connector assembly 20 moves telescopically between the first guide portion 314 and the second guide portion 324, so as to prevent the male connector assembly 20 from deviating due to an elastic force.

Based on the above embodiment, with reference to FIG. 6, the male connector assembly 20 is provided with an annular portion 21, the annular portion 21 is used for clamping the first interface 22, and abuts against the first limiting wall 312 and the second limiting wall 322. Optionally, the first interface may be a usb interface or an SD card interface. The annular portion 21 is connected with the shell 10 through a third elastic member 53 and carries the first interface 22 to switch between the accommodating state and the extending state. When a bottom surface of the annular portion 21 abuts against the limiting member 30, the first interface 22 extends from the shell 10.

The first elastic member 51 and the second elastic member 52 elastically move in a horizontal direction, and the third elastic member 53 elastically moves in a vertical direction.

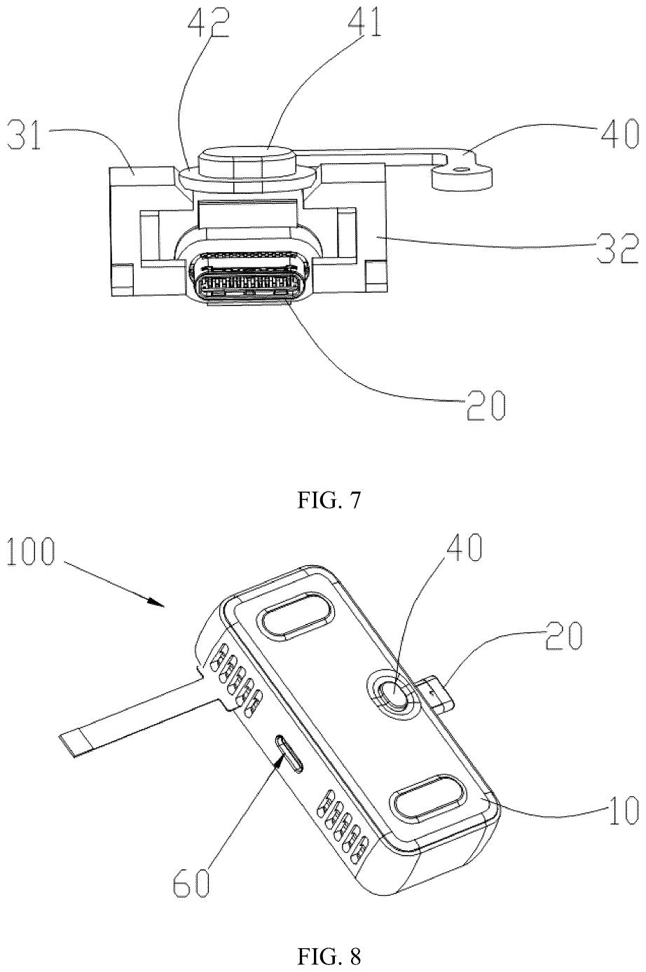

Based on the above embodiment, with reference to FIG. 7, one end of the controller 40 is provided with a pressing portion 41 and a moving portion 42, the pressing portion 41 is arranged on a surface of the shell 10, which is convenient for a user to press, two sides of the moving portion 42 abut against the first movable portion 31 and the second movable portion 32, the other end of the controller 40 is fixedly connected to an inner wall of the shell 10, and the pressing portion 41 is pressed to make the moving portion 42 increase the distance between the first movable portion 31 and the second movable portion 32.

Specifically, the user presses the pressing portion 41, so that two sides of the moving portion 42 push the first movable portion 31 and the second movable portion 32 away from each other, thus releasing the male connector assembly 20 in the accommodating state between the first movable portion 31 and the second movable portion 32, and meanwhile the first elastic member 51 and the second elastic member 52 are compressed. Specifically, the male connector assembly 20 ejects from the shell 10 under an action of the third elastic member 53, and after the male connector assembly 20 ejects from the shell 10, the pressing portion 41 is released, and the first movable portion 31 and the second movable portion are restored to original positions under actions of the first elastic member 51 and the second elastic member 52 to abut against the male connector assembly 20, so as to limit the male connector assembly 20 from retracting into the shell 10. At this time, the male connector assembly enters the extending state, and the first interface 22 may be connected with an external device. The pressing portion 41 is pressed again, so that two sides of the moving portion 42 push the first movable portion 31 and the second movable portion 32 away from each other again, the support for the male connector assembly 20 disappears, and then the male connector assembly 20 is manually pushed back into the shell 10, so as to return to the accommodating state.

By repeatedly pressing the pressing portion 41, the male connector assembly 20 may be switched between the accommodating state and the extending state, and meanwhile, the first elastic member 51, the second elastic member 52 and the third elastic member 53 are repeatedly compressed and stretched.

Further, the controller 40 controls a mutual movement distance of the first movable portion 31 and the second movable portion 32 to be greater than a length of two sides of the annular portion 21 abutting against the first limiting wall 312 and the second limiting wall 322, so that the first limiting wall 312 and the second limiting wall 322 release the male connector assembly 20 during the movement of the controller.

Based on the above embodiment, with reference to FIG. 8, the memory 100 with the telescopic data connector further comprises a second interface 60, the second interface 60 is arranged in the shell, and the second interface 60 is used for connecting the electronic device. The second interface may be set as required, such as a usb interface or a type-c interface.

During the use of the second interface 60, the first interface may retract and extend independently to switch between the accommodating state and the extending state, so as to be connected with other electronic devices, without interference with each other, thus adding a use function of the memory 100 with the telescopic data connector, and protecting the first interface 22 at the same time.

The above are merely preferred embodiments of the present invention, but are not intended to limit the patent scope of the present invention. Under the conception of the present invention, all equivalent structural transformations made by using the specification of the present invention and the contents of the drawings, or used directly/indirectly in other related technical fields, are included in the scope of protection of the present invention.

We claim:

1. A memory (100) with a telescopic data connector, wherein the memory (100) with the telescopic data connector comprises:
a shell (10);
a male connector assembly (20), wherein the male connector assembly (20) is elastically connected with the shell (10), and has an accommodating state of retracting into the shell (10) and an extending state of extending from the shell (10); and the male connector assembly (20) is used for connecting an electronic device;
a limiting member (30), wherein the limiting member (30) is arranged in the shell (10), the limiting member (30) limits the male connector assembly (20) from ejecting from the shell (10) in the accommodating state, and the limiting member (30) limits the male connector assembly (20) from retracting into the shell (10) in the extending state; and
a controller (40), wherein the controller (40) is arranged on the shell (10), the controller (40) is used for controlling the limiting member (30) to move, and the movement of the limiting member (30) allows the male connector assembly (20) to extend and retract elastically, so as to change the male connector assembly from the accommodating state to the extending state by ejecting from the shell (10), or change the male connector assembly from the extending state to the accommodating state by retracting into the shell (10).

2. The memory (100) with the telescopic data connector according to claim 1, wherein the limiting member (30) comprises a first movable portion (31) and a second movable portion (32), a first distance exists between the first movable portion (31) and the second movable portion (32), the controller (40) is arranged between the first movable portion (31) and the second movable portion (32), and the controller (40) is pressed to increase the first distance, so as to release a limitation on the male connector assembly (20).

3. The memory (100) with the telescopic data connector according to claim 2, wherein the first movable portion (31) is provided with a first inclined plane (311), and the second movable portion (32) is provided with a second inclined plane (321); the controller (40) abuts against the first inclined plane (311) and the second inclined plane (321) respectively; and when the controller (40) is pressed, the controller (40) slides along the first inclined plane (311) and the second inclined plane (321) at the same time, so as to squeeze out the first movable portion (31) and the second movable portion (32).

4. The memory (100) with the telescopic data connector according to claim 2, wherein the first movable portion (31) is connected with the shell (10) through a first elastic member (51), and the second movable portion (32) is connected with the shell (10) through a second elastic member (52); when the controller (40) is pressed, the first movable portion (31) and the second movable portion (32) compress the first elastic member (51) and the second elastic member (52) respectively; and after the first elastic member (51) and the second elastic member (52) are compressed, an elastic force is provided for restoring the first movable portion (31) and the second movable portion (32).

5. The memory (100) with the telescopic data connector according to claim 2, wherein the first movable portion (31) is provided with a first limiting wall (312), the second movable portion (32) is provided with a second limiting wall (322), the first limiting wall (312) and the second limiting wall (322) extend to approach each other, and the controller (40) is pressed to make the first limiting wall (312) and the second limiting wall (322) move away from each other and release the male connector assembly (20) for elastic movement.

6. The memory (100) with the telescopic data connector according to claim 5, wherein the male connector assembly (20) retracts between the first limiting wall (312) and the second limiting wall (322) in the accommodating state, the male connector assembly (20) abuts against an inner wall of the first limiting wall (312) and an inner wall of the second limiting wall (322), and is compressed by the first limiting wall (312) and the second limiting wall (322), and the male connector assembly (20) is limited from extending from the shell (10).

7. The memory (100) with the telescopic data connector according to claim 5, wherein the first movable portion (31) is provided with a first groove (313) and a first guide portion (314), the first guide portion (314) is arranged on one side of the first limiting wall (312), the second movable portion (32) is provided with a second groove (323) and a second guide portion (324), the second guide portion (324) is arranged on one side of the second limiting wall (322), and the male connector assembly (20) moves telescopically between the first guide portion (314) and the second guide portion (324).

8. The memory (100) with the telescopic data connector according to claim 2, wherein one end of the controller (40) is provided with a pressing portion (41) and a moving portion (42), the pressing portion (41) is arranged on a surface of the shell (10), two sides of the moving portion (42) abut against the first movable portion (31) and the second movable portion (32), the other end of the controller (40) is elastically connected to an inner wall of the shell (10), and the pressing portion (41) is pressed to make the moving portion (42) squeeze out the first movable portion (31) and the second movable portion (32).

9. The memory (100) with the telescopic data connector according to claim 8, wherein the male connector assembly (20) comprises an annular portion (21) and a first interface (22); the first interface (22) is used for connecting the electronic device, the annular portion (21) is used for clamping the first interface (22), the annular portion (21) is connected with the shell (10) through a third elastic member (53) and carries the first interface (22) to move synchronously; and when the first interface (22) extends from the shell (10), a bottom surface of the annular portion (21) abuts against the first movable portion (31) and the second movable portion (32).

10. The memory (100) with the telescopic data connector according to claim 2, wherein the memory (100) with the telescopic data connector further comprises a second interface (60), the second interface (60) is arranged in the shell, and the second interface (60) is used for connecting the electronic device.
